(19) United States
(12) Patent Application Publication
(10) Pub. No.: US 2004/0030602 A1
(43) Pub. Date: Feb. 12, 2004

(54) Computer-implemented method and system for managing supplier access to purchasing and inventory transactions

(76) Inventors: Edward G. Rosenquist, Plymouth, MI (US); Pattie J. Horning, Novi, MI (US); Robin L. Clinesmith, Livonia, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,264

(22) Filed: Jun. 18, 2003

Related U.S. Application Data
(60) Provisional application No. 60/390,014, filed on Jun. 19, 2002.

(51) Int. Cl. G06G 1/14; G06F 17/60

(52) U.S. Cl. 705/22; 705/28

(57) ABSTRACT

One aspect of the present invention is a computer-implemented method for managing supplier access to transaction information. In general, the method is comprised of receiving transaction information, selectively permitting access to the transaction information, and selectively prohibiting access to the transaction information. In certain embodiments, the transaction information is comprised of a first set of transaction information regarding transactions of a first plurality of items conducted between a first supplier and a buyer and a second set of transaction information regarding transactions of a second plurality of items conducted between a second supplier and the buyer. The first and second supplier are granted access to the first and second set of transaction information, respectively. The first and second supplier are denied access to the second and first set of transaction information, respectively.

### CROSS-REFERENCE TO RELATED APPLICATIONS

This application claims the benefit of U.S. provisional application Serial No. 60/390,014, filed Jun. 19, 2002, and entitled “Method and System for Managing Supplier Access to Purchasing and Inventory Transactions”.

### BACKGROUND OF THE INVENTION

1. Field of the Invention

One of the aspects of the present invention relates generally to a method and system for managing supplier access to purchasing and inventory transactions.

2. Background Art

A distributed enterprise refers to an organization having multiple operations spread across a multiple geographic regions, including continents and the entire world. In today's business environment, buyers in distributed enterprises use thousands of suppliers for the procurement of indirect materials. Indirect procurement includes the purchasing of resources that are necessary to bring about the manufacture of the product. In an automobile-manufacturing example, an indirect resource might include a day-to-day commodity such as wrenches or safety glasses that, although not technically a part of the automobile, are indirectly necessary to manufacture the automobile.

Using a multitude of suppliers presents a unique challenge to conventional electronic procurement management software. Most procurement systems are tailored to effectively meet the needs of smaller to mid-sized businesses having a few suppliers. These conventional systems lack functionality to effectively support certain business needs of distributed enterprises that use a multitude of suppliers.

Traditionally, electronic data interchange (EDI) and virtual private network (VPN) technologies have enable businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by increasing the speed and decreasing the cost associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

Today, distributed enterprises, such as General Electric and Compaq Computer, have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

One electronic procurement application is Oracle Procurement. A more detailed description of the Oracle Procurement application can be found at www.oracle.com. Other developers of procurement solutions include Ariba (www.ariba.com), i2 (www.i2.com), CommerceOne (www.commerceone.com), SAP (www.sap.com) and PeopleSoft (www.peoplesoft.com).

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. Patent Application No. 20010042050 to Fletcher et al. Additional information relating to electronic procurement systems includes Albert Pang's IDC White Paper eProcurement Ensures Visionary Companies a Place in the New Economy, July 2001.

Although today's procurement systems may be comprehensive and beneficial, the system suffers from certain disadvantages relating to the use of several suppliers. For example, the Oracle Purchasing Module does not have the ability to limit viewing of supplier purchasing and inventory transactions to only the responsible supplier. Consequently, suppliers can access other supplier's transaction in order to achieve a competitive advantage.

There is a need to provide a method and system to manage supplier access to purchasing and inventory transactions. This method and system should give suppliers the ability to manage their own, and only their own, transactions. Since several buyers, as well as other individuals can work with the same supplier, each of these individuals should be able to view documents supporting purchasing and inventory transactions for that supplier.

### SUMMARY OF THE PRESENT INVENTION

According to one embodiment of the present invention, the computer-implemented method for managing supplier access to transaction information regarding transactions of items conducted between suppliers and buyers is disclosed. In general, the method is comprised of receiving transaction information, selectively permitting access to the transaction information, and selectively prohibiting access to the transaction information.

The transaction information can be comprised of a first set of transaction information regarding transactions of a first plurality of items conducted between a first supplier and a buyer and a second set of transaction information regarding transactions of a second plurality of items conducted between a second supplier and the buyer. The step of selectively permitting access to the transaction information can be accomplished through a supplier access tool interface wherein the first supplier is granted access to the first set of transaction information and the second supplier is granted access to the second set of transaction information. The method further contemplates selectively prohibiting access to the transaction information through the supplier access tool interface wherein the second supplier is denied access to the first set of transaction information and the first supplier is denied access to the second set of transaction information. The transaction information can be relied upon by the first and second suppliers to maintain inventory levels of the first and second pluralities of items.

In certain embodiments, a method of the present invention can further comprise generating an inventory report based on at least some of the transaction information. Further, the method can include selectively replenishing the inventory levels of the first and second pluralities of items based on at least some of the transaction information. The selectively replenishing step can be conducted by the first and second suppliers. The method can further comprise conducting material control analysis of the first and second pluralities of items. The conducting step can be conducted by the first and second suppliers.

In certain method embodiments, the transactions are comprised of inventory transactions and purchasing transactions. In addition, the buyer can have first and second plants. In certain embodiments, each of the first and second pluralities of items are partially comprised of pay on receipt (POR) items. Each of the first and second pluralities of items can be partially comprised of pay on use (POU) items.

In certain method embodiments, the supplier access tool interface can include functionality for setting min/max planning levels. The supplier access tool interface can also include functionality for creating a plurality of auto-create requisitions for at least some of the first and second plurality of items. The method can further comprise converting at least some of the plurality of auto-create requisitions into a plurality of purchase orders. The supplier access tool interface can also include functionality for creating at least one manual requisition.

According to certain embodiments of the present invention, the first and second pluralities of items can be partially comprised of non-conforming items. The first and second suppliers can assist the buyer in procuring non-conforming items. The supplier access tool interface can also include functionality for viewing stock summary status. In certain embodiments, a method of the present invention can further include providing at least some of the transaction information from a supplier catalog. The supplier access tool interface can include functionality for updating descriptions of the first and second plurality of items. In addition, the supplier access tool interface can include functionality for updating purchase costs for the first and second pluralities of items.

In a computer-implemented system embodiment of the present invention, the system can be comprised of at least one server computer for communicating with at least two client computers. The at least one server computer can be configured to receive transaction information, selectively permit access to the transaction information, and selectively prohibit access to the transaction information.

The transaction information can be comprised of a first set of transaction information regarding transactions of a first plurality of items conducted between a first supplier and a buyer and a second set of transaction information regarding transactions of a second plurality of items conducted between a second supplier and the buyer. The system is configured to selectively permitting access to the transaction information through a supplier access tool interface wherein the first supplier is granted access to the first set of transaction information and the second supplier is granted access to the second set of transaction information. The system is configured to selectively prohibiting access to the transaction information through the supplier access tool interface wherein the second supplier is denied access to the first set of transaction information and the first supplier is denied access to the second set of transaction information. The transaction information can be relied upon by the first and second suppliers to maintain inventory levels of the first and second pluralities of items.

In another computer-implemented system embodiment of the present invention, the system can include two client computers for communicating with at least one server computer. The at least two client computers can be configured to transmit transaction information, receive a first access notification, and receive a second access notification.

The transaction information can be comprised of a first set of transaction information regarding transactions of a first plurality of items conducted between a first supplier and a buyer and a second set of transaction information regarding transactions of a second plurality of items conducted between a second supplier and the buyer. The system is configured to selectively permitting access to the transaction information through a supplier access tool interface wherein the first supplier is granted access to the first set of transaction information and the second supplier is granted access to the second set of transaction information. The system is configured to selectively prohibiting access to the transaction information through the supplier access tool interface wherein the second supplier is denied access to the first set of transaction information and the first supplier is denied access to the second set of transaction information. The transaction information can be relied upon by the first and second suppliers to maintain inventory levels of the first and second pluralities of items.

In another embodiment of the present invention, a computer-readable product for use in managing supplier access to transaction information regarding transactions of items conducted between suppliers and buyers is disclosed. The product is produced by a computer-implemented process, which comprises receiving a first set of transaction information regarding transactions conducted between a first supplier and a buyer, receiving a second set of transaction information regarding transactions conducted between a second supplier and the buyer, and storing the first and second set of transaction information in a computer-readable product for managing supplier access to transaction information regarding transactions of items conducted between the first and second suppliers and buyers.

According to yet another embodiment of the present invention, a program for controlling a computer of a server for managing supplier access to transaction information regarding transactions of items conducted between suppliers and buyers is disclosed. The program is comprised of instructions for receiving transaction information, instructions for selectively permitting access to the transaction information, and instructions for selectively prohibiting access to the transaction information.

The transaction information can be comprised of a first set of transaction information regarding transactions of a first plurality of items conducted between a first supplier and a buyer and a second set of transaction information regarding transactions of a second plurality of items conducted between a second supplier and the buyer. The instruction for selectively permitting access to the transaction information can include a supplier access tool interface wherein the first supplier is granted access to the first set of transaction information and the second supplier is granted access to the second set of transaction information. The instructions for selectively prohibiting access to the transaction information can include the supplier access tool interface wherein the second supplier is denied access to the first set of transaction information and the first supplier is denied access to the second set of transaction information. The transaction information can be relied upon by the first and second suppliers to maintain inventory levels of the first and second pluralities of items.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings:

FIG. 1 depicts a schematic diagram illustrating a system embodiment for implementing certain embodiments of the present invention;

FIG. 2 illustrates a flow chart of a standard relationship between users, employees, and contacts in accordance with the present invention;

FIG. 3 depicts a flow chart of an existing process for supplier requisitioning;

FIG. 4 is a GUI for setting access levels in accordance with an embodiment of the present invention;

FIG. 5 depicts a GUI for updating system profile values in accordance with an embodiment of the present invention; and

FIG. 6 is a GUI for inputting document types and information related to document types in accordance with an embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

### Supplier, Employee, and User Overview

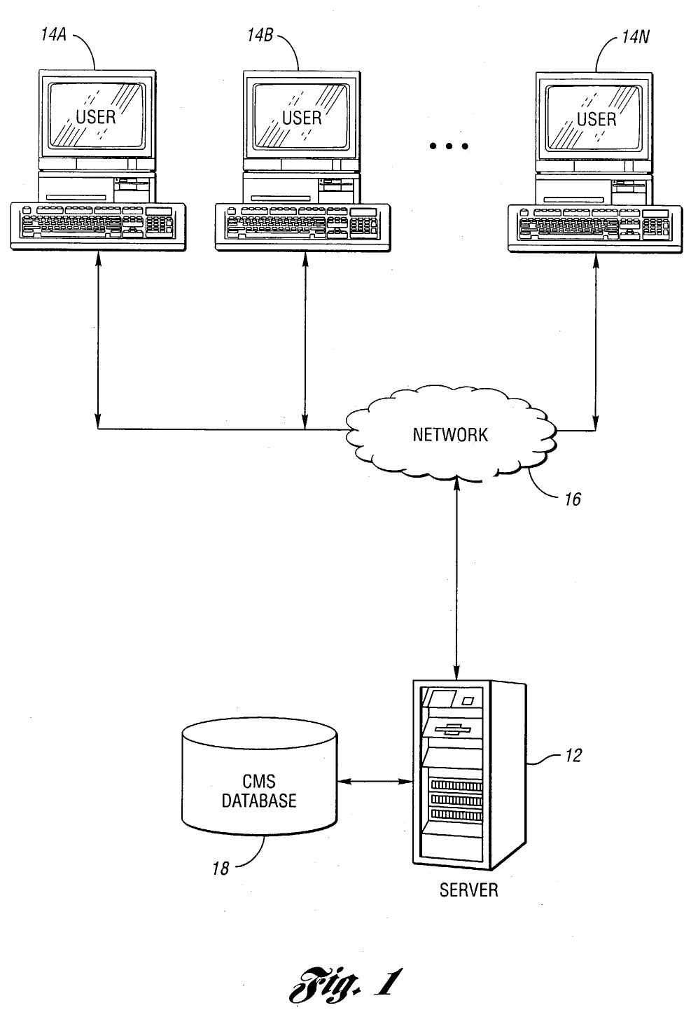

FIG. 1 depicts a schematic diagram illustrating a system embodiment for implementing certain embodiments of the present invention. It should be understood that the diagram is merely exemplary of certain embodiments. Elements of the diagram can be modified, rearranged, deleted, added upon, or amplified based on a particular embodiment of the present invention.

FIG. 1 illustrates an at least one server computer 12 operably serving a plurality of client computers 14a-n, which can communicate with server 12 utilizing a TCP-IP communication protocol via network/LAN 16. Server computer 12 can be configured to operably store information to, and retrieve data from, at least one commodity management supplier (CMS) database. Suppliers with buyer responsibility and internal requisitioners can utilize client computer 14 to access CMS database 18 through network 16 and server 12.

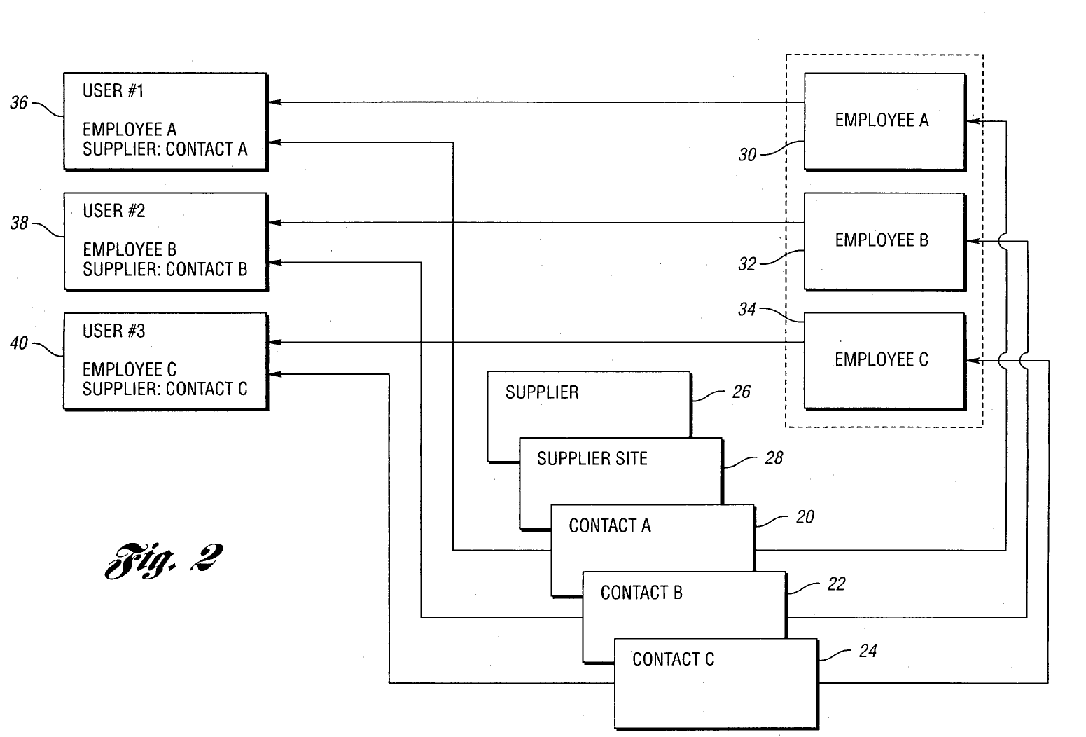

FIG. 2 illustrates a flow chart of a standard relationship between users, employees and contacts in accordance with the present invention. According to FIG. 2, contact A 20, contact B 22 and contact C 24, are employed by supplier 26 at supplier site 28. Employee A 30, employee B 32, and employee C 34 can be requisitioners working within the purchasing department of a distributed enterprise. According to block 36, a user relationship exists between employee A 30 and contact A 20. A user relationship 38 exists between employee B 32 and contact B 22, and a user relationship 40 exists between employee C and contact C 34. These relationships can be used to requisition goods or services to satisfy an originator's requirements.

Distributed enterprises have utilized suppliers to act as requisitioners, buyers and inventory control analysts supporting inventory, expense and project requisitions and purchase orders. A supplier functioning as a buyer, as well as a requisitioner should have the ability to view and manage all requisitions and purchase orders for each operating unit associated with the supplier's assigned responsibilities.

It should be understood that an Operating Unit (OU) refers to an organization that partitions data for sub-ledger products, such as Oracle Purchasing, Oracle Payables and Oracle Receivables. There can be many Operating Units within a legal entity.

It should be understood that a Requisition refers to an internal request for the purchasing department or buyer to procure goods or services to satisfy an originator's requirements. A requisition can originate from an employee or from another process, such as inventory or manufacturing. Each requisition can include many lines, generally with a distinct item on each requisition line. Each requisition line includes at least a description of the item, the unit of measure, the quantity needed, the price per item, and the general ledger account to be charged for the item.

### Overview of Supplier Material Requisition Process

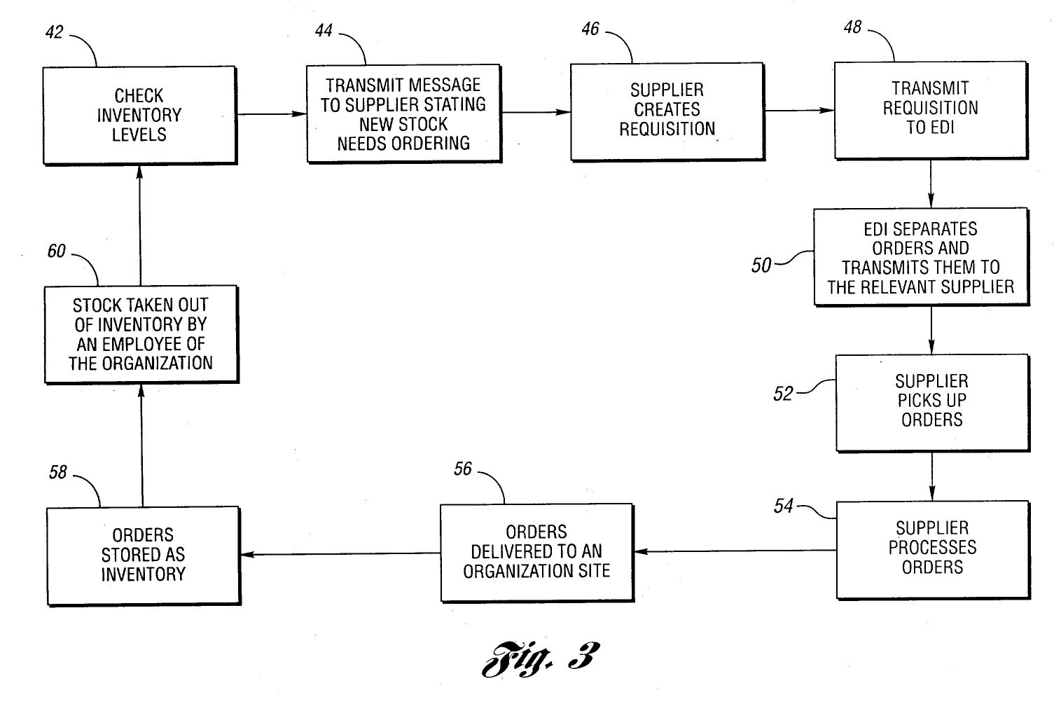

FIG. 3 depicts a flow chart of an existing process for supplier requisitioning. As depicted in block 42, inventory levels are checked. In block 44, a message is transmitted to a supplier stating new stock needs ordering. The supplier creates a requisition as depicted in block 46. The requisition is transmitted to electronic data exchange (EDI) 48. As depicted in block 50, EDI separates orders and transmits the orders to the relevant supplier. As depicted in blocks 52 and 54, the supplier picks up and processes orders. In block 56, the orders are delivered to an organization site. According to block 58, the orders are stored as inventory. In block 60, the stock is taken out of inventory by an employee of the organization. According to the arrow between blocks 60 and 42, the process depicted in FIG. 3 is at least partially continuous.

### Supplier Access Tool Functionality

One aspect of the supplier access tool enables the supplier to view parts for their supplier code. The supplier code can be a GSDB 4 or 5 digit code.

Another aspect of the supplier access tool enables a pay on use (POU) or pay on receipt (POR) supplier to manage items or parts by updating the item description and unit purchase cost only, as a commodity management supplier (CMS) for their GSDB 4 digit code.

It should be understood that an Item Master refers to a specific inventory organization in which all items are defined. A business would usually only have one item master, but it is possible to create many if required. Items are first created in the item master then assigned to other inventory organizations. Each inventory organization would normally hold a sub-set of the items held in the item master.

Another aspect of the supplier access tool restricts a supplier in the item master and item cost to only view the items and parts supplied to the distributed enterprise by the supplier's category codes.

Another aspect of the supplier access tool enables the supplier to view Inventory Management Screens for their supplier code.

Another aspect of the supplier access tool enables the supplier to create purchase requisitions for other suppliers.

Another aspect of the supplier access tool enables the supplier to create purchase order for other suppliers.

It should be understood that a Standard Purchase Order refers to a purchase order issued when goods or services are required for delivery for specific dates and locations for your company. Each standard purchase order line can have multiple shipments and the quantity of each shipment can be distributed against multiple general ledger accounts. A requisition can be used to create a standard purchase order, but is not mandatory.

Another aspect of the supplier access tool enables the supplier to create blanket purchase orders for other suppliers.

Another aspect of the supplier access tool enables the supplier to view requisitions and purchase orders issued by the supplier.

Another aspect of the supplier access tool enables the supplier to view Purchase Orders and related documents issued to them, in certain embodiments, by accessing a Supplier Portal.

Another aspect of the supplier access tool included the ability to generate reports for inventory management, i.e., planners reports, items, cost of items, inventory transactions, etc. The reports can be restricted by the Supplier Category Code and may not display cost of items and parts managed by other suppliers.

Another aspect of the supplier access tool enables the supplier to view Purchase Order Amendments for their Supplier Code.

Another aspect of the supplier access tool enables the supplier to view RFQs for their Supplier Code.

Another aspect of the supplier access tool enables the supplier to view their Receiving History.

Another aspect of the supplier access tool enables the supplier to view their Payment History and Scheduled Payments.

Another aspect of the supplier access tool enables the supplier to view and manage purchasing documents and run reports by Supplier Code.

Another aspect of the supplier access tool enables a supplier to view and manage inventory items and run reports based on a securing Supplier Code and a Supplier Category Set.

### Implementation Of The Supplier Access Tool Functionality

The existing Oracle Supplier Access Module can be customized to allow: (1) the supplier to create requisitions and purchase Orders within the core applications, (2) the supplier to view all purchasing documents, for example, requisitions, RFQs, quotations, and purchase orders, created by the supplier within the core applications or requisition tracking, (3) issuing of amendments against POs to the originating supplier, (4) the supplier to view, plan and update parts supplied and managed by the supplier, by their specific responsibility, and (5) the supplier can continue to access the I-Supplier Portal for purchase orders issued to the supplier for management, for example, viewing purchase orders, RFQs, quotations, and advanced shipping notice (ASN) management.

It should be understood that a Responsibility refers to a grouping of functionality and system data often related to a job role. Responsibilities are associated with an operating unit.

The following steps can be executed for implementation presented in no particular order of execution, within the Oracle Supplier Access Module: (1) create an “Internal Supplier” menu to limit core applications menu options, (2) create an “Internal Supplier” responsibility, or responsibilities, and attach the “Internal Supplier” menu, (3) create an “Internal Supplier” report group to limit reports available to supplier, (4) create a supplier, supplier site and supplier site contacts, (5) create employee records to match the supplier site contacts, (6) create a buyer record for each “supplier” employee, (7) create a user record for each “supplier” employee, (8) attach the employee name and supplier contact name and set the custom Supplier securing attribute on each user record, (9) attach the relevant “Internal Supplier” responsibility on each user record, and (10) attach the relevant “iSupplier Portal” responsibility and set the iSupplier Portal securing attributes on each user record.

It should be understood that a Menu Item refers to any option on the Oracle Applications navigation menu for this user.

The following customizations can be made to the Oracle Supplier Access Module in order to secure, restrict, remove or set forms and fields so that suppliers have the ability to access their transactions. It should be understood that a form refers to a predefined grouping of functions, called from a menu and displayed, if necessary, on several windows. A form is a logical collection of blocks, regions and fields that appears on a single screen. Oracle Applications forms resemble paper forms used to run a business. Data is entered by typing information into the form.

In the Purchase Order Form, the supplier and supplier contact field can be set to the supplier's default value, the part numbers and categories fields can be restricted depending on supplier, and the currency button is disabled.

In the Requisitions Form, the Supplier Field can be set to the supplier's default value.

In the Shipments Form, the Org, Ship To, and Tax Code fields can be set to the supplier's default. In the More Tab of Shipments form, the Receipt Tolerance Field and Invoice Tolerance Field can be grayed out. In the Destination Tab of the Shipments Form, the Charge Account Field can be set to the supplier's default.

In the Receipts Form, Purchase Order, Requisitioner, Supplier, and Receiving Location Fields can be restricted by the Supplier. In the Item Tab of the Receipts Form, the Item and Category Fields can be restricted so that suppliers can only see their relevant Part Numbers.

RFQs can be restricted since RFQs go through the I-Supplier Portal.

In the Manage Buyer Workload Form, the Requisition Numbers, Requestor, Buyer Name, Supplier Name, Ship To, Item, and Category Fields can be restricted.

In the PO Change History Form, the supplier can be confined to the I-Supplier Portal.

Disable “Catalog” button on the Purchase Order Form and the Requisition Form using function exclusions.

On the Define PO Screen, the data elements for document type pick list can be amended to show only “Standard Purchase Order” and “Blanket Purchase Agreements” upon creation of a purchase order. On the PO Summary Screen, viewing can be enabled for all purchase orders, regardless of the type, created by the supplier's users only.

It should be understood that a Blanket Purchase Agreement (BPA) refers to a type of purchase order issued before actual delivery of goods or services is requested from the supplier. A BPA is normally created to document a long-term supplier agreement, and can contain an effective date and an expiration date, a committed amount, or quantity, price breaks. A BPA is used as a tool for specifying agreed prices and delivery dates for goods and services before ordering them.

It should be understood that Price Breaks refers to a part of a blanket purchase agreement or global blanket order and contain ship to and inventory locations plus the associated unit price and quantity.

In the Purchase Requisition Form, user searches are limited to of blanket orders for the supplier's blanket.

In the Purchase Order Form, the supplier can select any Supplier setup in the Supplier tables. In the same form, the data elements can limit the item inventory part numbers to be selected and ordered to the supplier's Part Numbers. In the same form, buyers can have the ability to buy from non-CMS suppliers.

In the Requisitions Summary Form, the data elements can limit viewing of requisitions to those created by the supplier's users.

In the AutoCreate Form, the options “Remove planned PO” and “Blanket Release” can be removed from the Document Type field and the data elements can limit query requisitions to those created by the supplier's users.

It should be understood that a Blanket Release refers to an actual order of goods or services against a BPA. The BPA determines the characteristics and prices of items. The blanket release specifies actual quantities and dates ordered for the items. A blanket release can be identified by the combination of the BPA number and the release number. The relationship between a blanket release and a global blanket order will be exactly the same as described here between a blanket release and a BPA.

It should be understood that a Global Blanket Order refers to a Blanket Purchase Agreement that is enabled in more than one operating unit.

In the More Tab of the purchase order form, the Receipt Tolerance and Invoice Tolerance Fields can be grayed out. In the Destination Tab of the Shipments form, the Charge Account Field can be set to the supplier's default.

In the Receipts Form, the data elements can limit the search scope by supplier entry.

In the receiving transactions summary form, the data elements can limit the search by receipts and purchase orders functionality by the supplier's entries.

In the Purchase Amendment form, data elements can limit supplier queries to standard purchase orders created by the supplier's buyers and requisitions created by the supplier's requesters, or POs issued to them.

In the Receiving Transactions Summary Form, the Purchase Order, Requisition, Supplier, and Receiving Location Fields can be restricted by the entries created by the supplier's users. In the Receipt Number Field, the supplier can have the ability to see their own Receipt Numbers created against documents generated by their users.

For the Min-Max Planning report, the data elements for the inventory CMS can limit the supplier to running the report for their sub-inventories, in combination with the CMS Category Code for pay on use and pay on receipt.

In the organization items form, the data elements can limit the supplier to query and maintain items within the supplier's inventory organization.

It should be understood that an Inventory Organization (IO) refers to an organization that tracks inventory transactions and balances, and/or that manufactures or distributes products.

In the on-hand inventory form, the data elements can limit the supplier to query and maintain items within the supplier's inventory organization.

In the planner's workbench, the data elements can limit the supplier to run and manage items within the supplier's individual inventory organization.

In the RFQ Form and the Quotation Form, the data elements can limit the query to view and copy documents created by the supplier's users.

The buyer can have the ability to reassign a purchase order to a supplier's buyer to be managed and maintained.

In the PO Change History browser form, the data elements can limit a supplier search to documents created by the supplier's users or issued to the supplier.

Category codes can be setup with the first characters being the 4 digit GSDB code and the second part being POU or POR with a period separating the two values.

The supplier category codes, i.e. GSDB.POU or GSDB.POU, can be setup under the “CMS Supplier Inventory” Category Set.

Suppliers who have access to raise orders cannot manage their individual approval paths for requisitions, purchase orders, planners' approvals, users, employees, or securing attributes.

The Rate Type Field, Currency Field, Unit Of Measure Field, and Tax Code Field can be restricted for limited access.

Reports specifically designed for inventory management can be written with parameters built around the user's securing attributes and the system item category codes.

New items can be setup by the inventory management processes and assigned to the proper category code and category can be set prior to being placed or sourced on a Blanket Purchase Order by the supplier.

Suppliers unique Inventory Organizations can be setup and Subinventories can be created and managed by the inventory team for all CMS items, which will insure correct supplier credit and debits. For example, inventory organization can be A01 and GSDB Code can be 4608.

According to certain embodiments of the present invention, systems are disclosed to enable the supplier to view requisitions issued by the supplier based on the supplier's supplier code.

In certain embodiments, a system includes setting a category securing attribute at the responsibility level, assigning a value for the category at the user level. For instance, the securing attribute at the responsibility level could be Supplier and the value for this category at the user level could be, for example, “Supplier A/Site 1” or “Supplier B/Site 2”.

According to this system, the Requisition Summary Screen form, the Autocreate form, the Manage Buyer Workload form, and CUSTOM.PLL for these forms, can be amended so that the securing attributes for the user are checked and the only requisitions shown include those (1) created by users that have the same securing attribute and (2) created for the supplier and site, for example standard supplier and site fields for the requisition, which match those on the securing attribute for this user.

The following customization, in no particular order, can be made to the Oracle Supplier Access system in order to implement the system: (1) create a new responsibility level securing attribute “INTERNAL_SUPPLIER_ACCESS”, (2) create supplier responsibility and link to the new securing attribute, (3) create a new user level securing attribute “INTERNAL_SUPP_ACCESS_SITE”, (4) create a user for this supplier and link to the new securing attribute, (5) choose the relevant supplier and site as the valid values for this securing attribute, and (6) update the CUSTOM.PLL to restrict visibility of requisitions as described above.

Another system of enabling the supplier to view requisitions issued by the supplier based on the supplier's supplier code includes creating a Descriptive Flexfield (DFF) on the Buyer table and holding the relevant supplier and site against each “supplier buyer”. It is understood that the buyer refers to the employee name and the employee name is linked to a user. Each buyer created for the same internal supplier has the same value in the DFF.

It should be understood that a Descriptive Flexfield (DFF) refers to a field that can be extended to capture extra information, which would not otherwise be tracked by Oracle Applications. A descriptive flexfield appears in a form as a single character, unnamed field. [ ] denotes a descriptive flexfield.

According to this system, the Requisition Summary Screen form, the Autocreate form, the Manage Buyer Workload form, and CUSTOM.PLL for these forms, can be amended so that the value in the DFF for this buyer is checked and the only requisitions shown include those: (1) created by users that have the same value in the DFF against their buyer record and (2) created for the supplier and site, i.e. standard supplier and site fields for the requisition, which match those on the DFF for this user's buyer record.

The following customizations, in no particular order, can be made to the Oracle Supplier Access system in order to implement the system: (1) create a new DFF on the buyer record (the value set for this DFF should be first validated against the Supplier table, and secondly against the Supplier site table to ensure that when a supplier is chosen only the valid sites are available to pick), (2) set DFF on “supplier” buyer records to the relevant Supplier and Site values, and (3) update CUSTOM.PLL to restrict visibility of requisitions as described above.

Another system of enabling the supplier to view requisitions issued by the supplier based on the supplier's supplier code includes establishing a link between the supplier contact name and the employee name held on the user record.

According to this system, the Requisition Summary Screen form, the Autocreate form, the Manage Buyer Workload form, and CUSTOM.PLL for these forms, can be amended so that the supplier contact name for the current user record is checked, the supplier and supplier site for the supplier contact name is found, and the only requisitions shown include those: (1) created by users that are linked, via their supplier contact name to the same supplier and site as the current user and (2) created for the supplier and site, i.e., standard supplier and site fields for the requisition, which link to the current user's supplier contact name.

Another system of enabling the supplier to view requisitions issued by the supplier based on the supplier's supplier code includes creating an “Assignment Table” to hold a link between user records and supplier and supplier sites. Each record in the table can have a unique assignment ID. As user records are created, the link is made by navigating to a custom form either via the “Tools” menu, a new “Tools” type menu, or via a new button on the form. The user can select one supplier and site from validated pick lists and links these to the user record.

It should be understood that an Assignments Table refers to the concept that in the existing Oracle Applications multi-org architecture, a given purchasing document belong to a single OU. Hence, each application's database table has a single column holding the (unique) organization ID (“ORG_ID”). However, there exists a need to link many purchasing documents to many OUs. At the very least, therefore, a custom database table is required to resolve this many-to-many relationship.

It should be understood that an Organization ID (ORG_ID) refers to the database ID number for an operating unit held within Oracle Applications. The ID number depends on the order in which the operating units are created within Oracle Applications.

According to this system, the Requisition Summary Screen form, the Autocreate form, the Manage Buyer Workload form, and CUSTOM.PLL for these forms, can be amended so that the “Assignment Table” can be checked, the supplier and supplier site for this user is found, and the only requisitions shown include those: (1) created by users that are linked via the “Assignments Table,” to the same supplier and site as the current user and (2) created for the supplier and site, i.e., standard supplier and site fields for the requisition, which are linked to in the “Assignments Table.”

The following customizations, in no particular order, can be made to the Oracle Supplier Access system in order to implement the system: (1) create an “Assignments Table” to hold a link between user records and suppliers and supplier sites, (2) create custom forms for Requisition Summary Screen, Autocreate, and Manage Buyer Workload, and (3) update CUSTOM.PLL to restrict visibility of requisitions as described above.

Another system of enabling the supplier to view requisitions issued by the supplier based on the supplier's supplier code includes creating a new profile option “SUPPLIER_ACCESS” which is set at the responsibility or user level. The profile option can be set by a system administrator and holds the relevant supplier and supplier site. If a responsibility is unique to a supplier, then this profile option can be set at responsibility level and all users with the same responsibility are linked to same supplier. If a responsibility is used for many suppliers, the profile option can be set at user level.

According to this system, the Requisition Summary Screen form, the Autocreate form, the Manage Buyer Workload form, and CUSTOM.PLL for these forms, can be amended so that the value in the “SUPPLIER_ACCESS” profile option for this user is checked, and the only requisitions shown would be those: (1) created by users that have the same value in the profile option and (2) that have been created for the supplier and site, i.e., standard supplier and site fields for the requisition, which match those on the profile option for this user.

The following customizations, in no particular order, can be made to the Oracle Supplier Access system in order to implement the system: (1) create a new profile option “SUPPLIER_ACCESS”, (2) set the “SUPPLIER_ACCESS” profile option at the relevant level, and (3) update CUSTOM.PLL to restrict visibility of requisitions as described above.

Several systems are disclosed to enable the supplier to view Purchase Orders and related documents issued to them. The systems are similar to the systems for enabling the supplier to view requisitions issued by the supplier except that the effected forms are “Purchase Order Summary Screen” and “Enter Purchase Order Screen”.

Another system of enabling the supplier to view Purchase Orders and related documents issued to them includes using the iSupplier Portal as standard. The supplier's employee logging on can see all purchase orders for this supplier only.

According to certain embodiments of the present invention, systems are disclosed to enable the supplier to view Purchase Order Amendments for their Supplier Code. The systems are similar to the systems for enabling the supplier to view requisitions issued by the supplier except that the affected form is “Purchase Order History Screen”.

Another system of enabling the supplier to view Purchase Order Amendments for their Supplier Code includes using iSupplier Portal as standard. The supplier's employee logging on can see all purchase order amendments for this supplier's purchase orders only.

According to certain embodiments of the present invention, systems are disclosed to enable the supplier to view their RFQs for their Supplier Code. The systems are similar to the systems for enabling the supplier to view requisitions issued by the supplier except that the affected form is “Define RFQ Screen”.

Another system of enabling the supplier to view their RFQs for their Supplier Code includes using the iSupplier Portal as standard. The supplier's employee logging on can see all RFQ's for this supplier only.

According to certain embodiments of the present invention, systems are disclosed to enable the supplier to view their Receiving History. The systems are similar to the systems for enabling the supplier to view requisitions issued by the supplier except that the affected forms are “Enter Receipts” and “Receiving Transaction Summary.”

Another system of enabling the supplier to view their Receiving History includes using iSupplier Portal as the standard. The supplier's employee logging on can see all Receipts for this supplier only.

A system of enabling the supplier to view their Payment History and Scheduled Payments includes using iSupplier Portal as the standard. The supplier's employee logging on can see Payment History and Scheduled Payments for this supplier only.

A system is disclosed to enable the supplier to view and manage purchasing documents and run reports. The includes using a securing attribute. For instance, the securing attribute at responsibility can be ‘ICX_Supplier_ORG_ID’ and the value could be the four-digit supplier GSDB code.

According to this system, the Requisition Summary Screen form, the Requisition Entry form, the Requisition Autocreate form, Purchase Order Summary form, Purchase Order Entry form, RFQ entry form, Quotation Entry form, Item entry form, Receiving form, Receiving Transaction Summary form, On Hand quantities form, the planners workbench form and the CUSTOM.PLL data elements for these forms can be modified so that the securing attributes for the supplier user would be checked to manage views and entries: (1) created by users that have the same securing attribute value, (2) based on supplier GSDB code and whether the transaction is POR or POU, or (3) (1) and (2).

The following customizations, in no particular order, can be made to the Oracle Supplier Access system in order to implement the system: (1) create supplier responsibility and link to the securing attribute ICX_SUPPLIER_ORG_ID, (2) create supplier requisition and purchasing menu, (3) create supplier requisitioner and purchasing request set for generating required concurrent processes, (4) create supplier requisition and purchasing responsibility, (5) link the responsibility to the new supplier requisitioning and purchasing menu and Request Groups with ICX_SUPPLIER_ORG_ID securing attribute, (6) create a user for a supplier and assign the ICX_SUPPLIER_ORG_ID securing attribute, and (7) update CUSTOM.PLL, using dynamic SQL to restrict visibility as described above.

A system is disclosed to enable a supplier to view and manage inventory items and run reports based on a securing Supplier Code and a Supplier Category Set. The system includes using a securing attribute. For instance, a securing attribute at the responsibility level could be ‘ICX_Supplier_ORG_ID’ and ICX_CATEGORY_ID mostly utilizing the 4 digit supplier GSDB code.

According to this system, the Item entry form, the Item Min-Max form, the Receiving form, the Receiving Transaction Summary, the On Hand quantities form, the planners workbench and the CUSTOM.PLL data elements for these forms can be amended so that the securing attributes for the supplier user would be checked to manage views and entries: (1) created by users that have the same securing attribute value, (2) based on supplier GSDB code and whether the transaction is POR or POU or (3) (1) and (2).

The following customization, in no particular order, can be made to the Oracle Supplier Access system in order to implement the system: (1) create supplier inventory management menu, (2) create supplier inventory management request set for generating required concurrent processes, (3) create supplier inventory management responsibility, (4) link the responsibility to the new supplier inventory management menu and request groups with ICX_SUPPLIER_ORG_ID and ICX_CATEGORY_ID securing attributes, (5) update CUSTOM.PLL, using dynamic SQL to restrict visibility as described above, and (6) create custom reports.

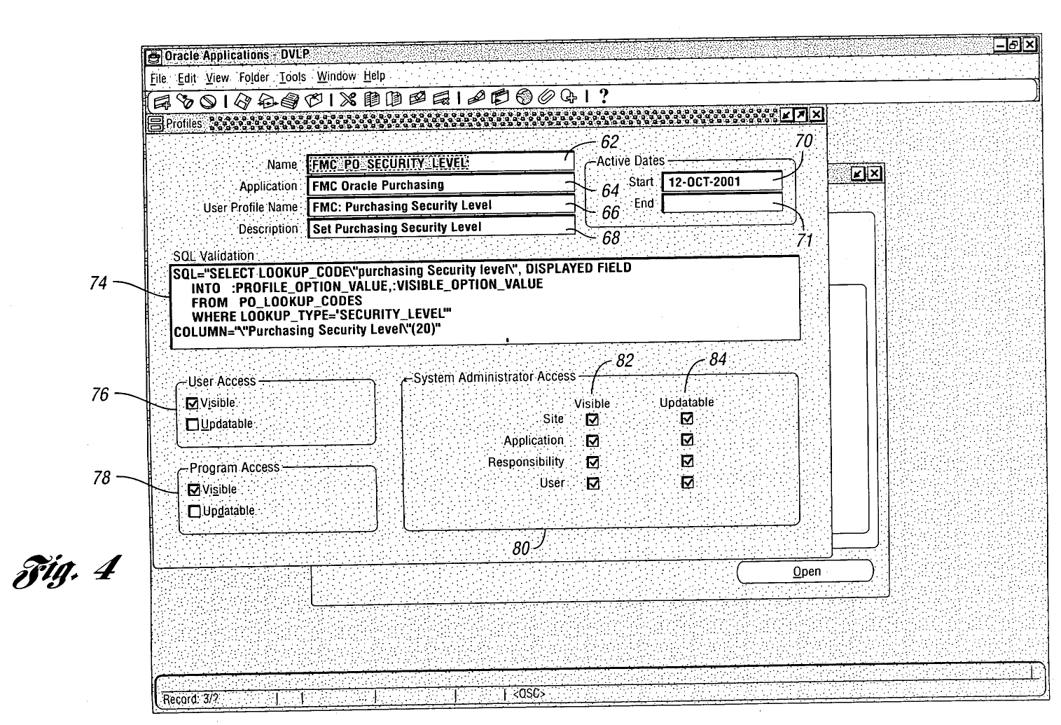

FIGS. 4 through 6 are graphical user interfaces (GUIs) implementing the supplier access tool functionality in order to secure, restrict, remove or set forms and fields so that suppliers have the ability to access their transactions in accordance with an embodiment of the present invention.

FIG. 4 is a GUI for setting access levels in accordance with an embodiment of the present invention. According to FIG. 4, name, application, user profile name, and description can be input into text input boxes 62, 64, 66, and 68, respectively. Active dates can be set in start input box 70 and end input box 72. Text window 74 can display SQL validation code. User access box 76 includes a visible access click box and an updatable access click box. These click boxes can be toggled from checked to not checked by the user. Program access box 78 includes a visible checkbox and an updatable checkbox. System administrator access box 80 includes column 82 and 84 for visible check boxes and updatable check boxes, respectively. Each column 82 and 84 can include four check boxes (cite, application, responsibility, and user).

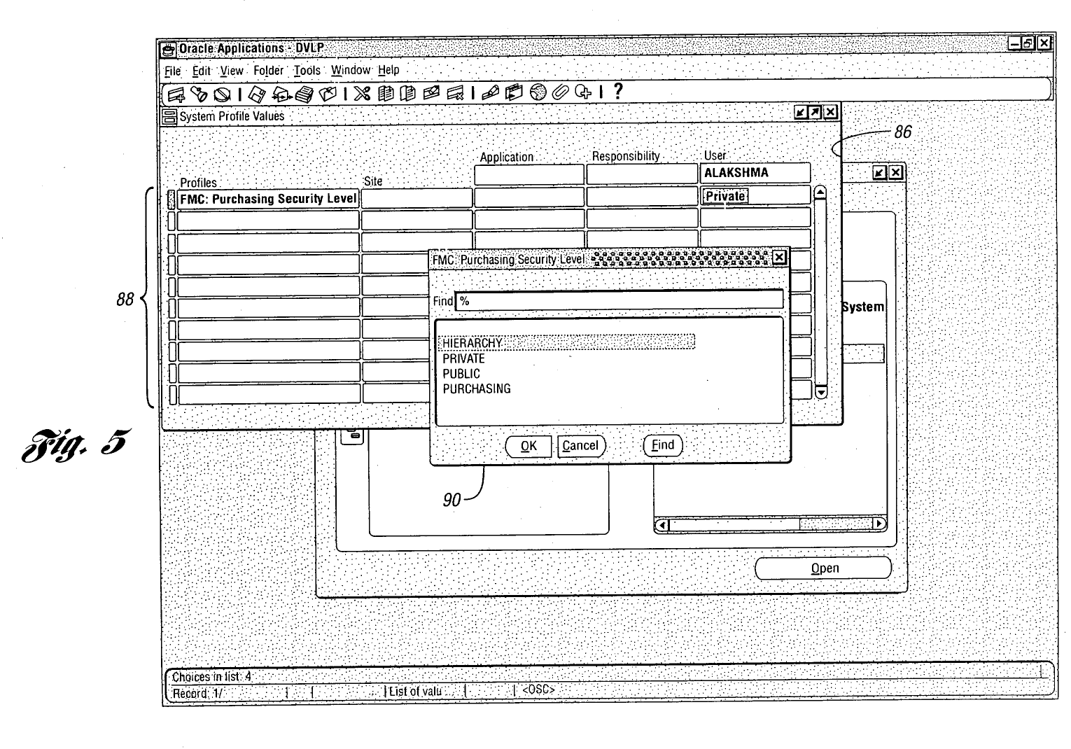

FIG. 5 depicts a GUI for updating system profile values in accordance with an embodiment of the present invention. GUI 86 includes spreadsheet 88 for updating, modifying, and deleting system profile values. Spreadsheet 88 includes, but is not limited to, the following columns: profile, site, application, responsibility, and user. A user can select the purchasing security level from pop-up window 90.

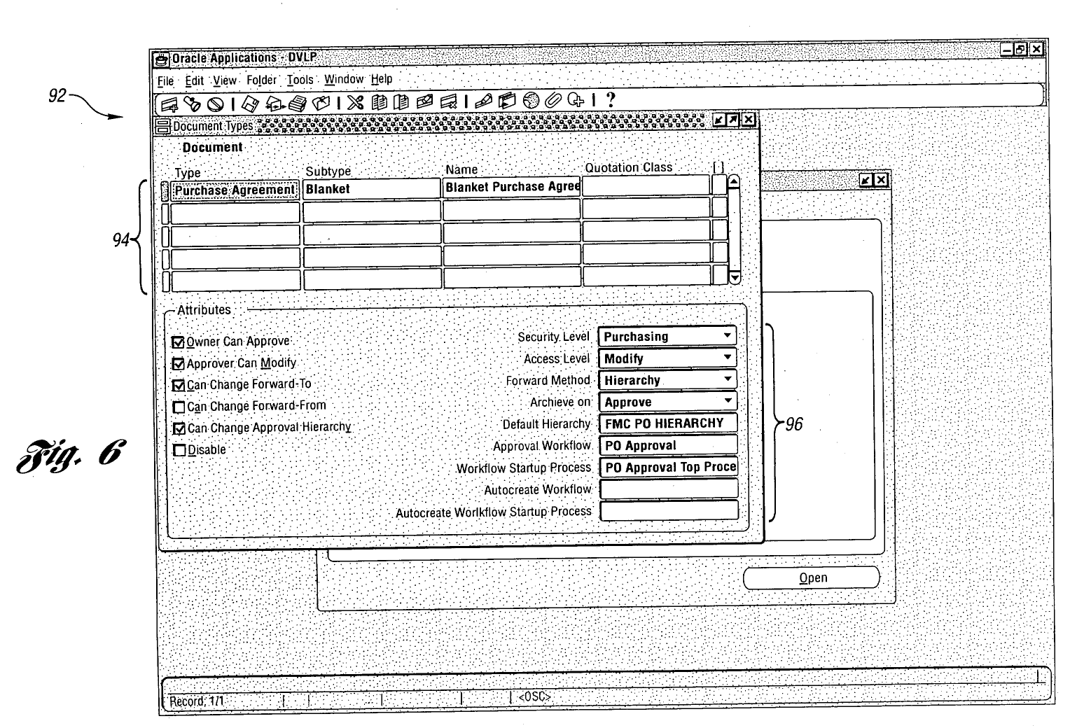

FIG. 6 is a GUI for inputting document types and information related to the document types in accordance with an embodiment of the present invention. GUI includes spreadsheet 94 and attributes box 96 for inputting information regarding documents and attributes of those documents. Spreadsheet 94 includes the following columns: type, subtype, name, and quotation class. Attributes box 96 include check boxes for certain attributes, drop down boxes, and input text boxes. Attribute check boxes can include, but is not limited to, the following: owner can approve, approver can modify, can change forward-to, can change forward-from, can change approval hierarchy, and disable. The drop down boxes can include, but is not limited to, information for security level, access level, forward message, and archive on. The text input boxes can include information for default hierarchy, approval work flow, work flow start up process, auto create work flow, and auto create work flow start up process.

While the best mode for carrying out the invention has been described in detail, those familiar with the art to which their invention relates will recognize various alternative designs and embodiments for practicing the invention as defined by the following claims.

What is claimed:

1. A computer-implemented method for managing supplier access to transaction information regarding transactions of items conducted between suppliers and buyers, the method comprising:
receiving transaction information wherein the transaction information is comprised of a first set of transaction information regarding transactions of a first plurality of items conducted between a first supplier and a buyer and a second set of transaction information regarding transactions of a second plurality of items conducted between a second supplier and the buyer; and
selectively permitting access to the transaction information through a supplier access tool interface wherein the first supplier is granted access to the first set of transaction information and the second supplier is granted access to the second set of transaction information,
whereby the transaction information is relied upon by the first and second suppliers to maintain inventory levels of the first and second pluralities of items.

2. The method of claim 1 further comprising selectively prohibiting access to the transaction information through the supplier access tool interface wherein the second supplier is denied access to the first set of transaction information and the first supplier is denied access to the second set of transaction information.

3. The method of claim 1 further comprising generating an inventory report based on at least some of the transaction information.

4. The method of claim 1 further comprising selectively replenishing the inventory levels of the first and second pluralities of items based on at least some of the transaction information.

5. The method of claim 4 wherein the selectively replenishing step is conducted by the first and second suppliers.

6. The method of claim 5 further comprising conducting material control analysis of the first and second pluralities of items.

7. The method of claim 6 wherein the conducting step is conducted by the first and second suppliers.

8. The method of claim 1 wherein the transactions are comprised of inventory transactions and purchasing transactions.

9. The method of claim 1 wherein the buyer has first and second plants.

10. The method of claim 1 wherein each of the first and second pluralities of items are partially comprised of pay on receipt (POR) items.

11. The method of claim 1 wherein each of the first and second pluralities of items are partially comprised of pay on use (POU) items.

12. The method of claim 1 wherein the supplier access tool interface includes functionality for setting min/max planning levels.

13. The method of claim 1 wherein the supplier access tool interface includes functionality for creating a plurality of auto-create requisitions for at least some of the first and second plurality of items.

14. The method of claim 13 further comprising converting at least some of the plurality of auto-create requisitions into a plurality of purchase orders.

15. The method of claim 1 wherein the supplier access tool interface includes functionality for creating at least one manual requisition.

16. The method of claim 1 wherein the first and second pluralities of items are partially comprised of non-conforming items.

17. The method of claim 16 wherein the first and second suppliers assist the buyer in procuring the non-conforming items.

18. The method of claim 1 wherein the supplier access tool interface includes functionality for viewing stock summary status.

19. The method of claim 1 further comprising providing at least some of the transaction information from a supplier catalog.

20. The method of claim 19 wherein the supplier access tool interface includes functionality for updating descriptions of the first and second pluralities of items.

21. The method of claim 19 wherein the supplier access tool interface includes functionality for updating purchase costs for the first and second pluralities of items.

22. A computer-implemented system for managing supplier access to transaction information regarding transactions of items conducted between suppliers and buyers, the system comprising at least one server computer for communicating with at least two client computers, the at least one server computer being configured to:
receive transaction information wherein the transaction information is comprised of a first set of transaction information regarding transactions conducted between a first supplier and a buyer and a second set of transaction information regarding transactions conducted between a second supplier and the buyer; and
selectively permit access to the transaction information through a supplier access tool interface wherein the first supplier is granted access to the first set of transaction information and the second supplier is granted access to the second set of transaction information,
whereby the transaction information is relied upon by suppliers and buyers to maintain inventory levels of items.

23. The system of claim 22 wherein the at least one server computer is further configured to selectively prohibit access to the transaction information through the supplier access tool interface wherein the second supplier is denied access to the first set of transaction information and the first supplier is denied access to the second set of transaction information.

24. A computer-implemented system for managing supplier access to transaction information regarding transactions of items conducted between suppliers and buyers, the system comprising at least two client computers for communicating with at least one server computer, the at least two client computers being configured to:
transmit transaction information wherein the transaction information is comprised of a first set of transaction information regarding transactions conducted between a first supplier and a buyer and a second set of transaction information regarding transactions conducted between a second supplier and the buyer; and
receive a first access notification for selectively permitting access to the transaction information through a supplier access tool interface wherein the first supplier is granted access to the first set of transaction information and the second supplier is granted access to the second set of transaction information,
whereby the transaction information is relied upon by suppliers and buyers to maintain inventory levels of items.

25. The system of claim 24 wherein the at least two client computers are further configured to receive a second access notification for selectively prohibiting access to the transaction information through the supplier access tool interface wherein the second supplier is denied access to the first set of transaction information and the first supplier is denied access to the second set of transaction information.

26. A computer-readable product for use in managing supplier access to transaction information regarding transactions of items conducted between suppliers and buyers, the product being produced by a computer-implemented process, the process comprising:
receiving a first set of transaction information regarding transactions conducted between a first supplier and a buyer;
receiving a second set of transaction information regarding transactions conducted between a second supplier and the buyer; and
storing the first and second set of transaction information in a computer-readable product for managing supplier access to transaction information regarding transactions of items conducted between the first and second suppliers and buyers.

27. A program for controlling a computer of a server for managing supplier access to transaction information regarding transactions of items conducted between suppliers and buyers, the program comprising:
instructions for receiving transaction information wherein the transaction information is comprised of a first set of transaction information regarding transactions conducted between a first supplier and a buyer and a second set of transaction information regarding transactions conducted between a second supplier and the buyer; and
instructions for selectively permitting access to the transaction information through a supplier access tool interface wherein the first supplier is granted access to the first set of transaction information and the second supplier is granted access to the second set of transaction information,
whereby the transaction information is relied upon by suppliers and buyers to maintain inventory levels of items.

28. The program of claim 27 further comprising instructions for selectively prohibiting access to the transaction information through the supplier access tool interface wherein the second supplier is denied access to the first set of transaction information and the first supplier is denied access to the second set of transaction information.
